(19) United States
(12) Patent Application Publication
(10) Pub. No.: US 2007/0229404 A1
(43) Pub. Date: Oct. 4, 2007

(54) Plasma display apparatus and driving method thereof

(75) Inventor: Kyoung Hoon Lee, Dalseo-gu (KR)

Correspondence Address: KED & ASSOCIATES, LLP, P.O. Box 221200, Chantilly, VA, 20153-1200, US

(73) Assignee: LG Electronics Inc.

(21) Appl. No.: 11/730,596

(22) Filed: Apr. 3, 2007

(30) Foreign Application Priority Data
Apr. 3, 2006 (KR) 10-2006-0030240

(51) Int. Cl. G09G 3/28

(52) U.S. Cl. 345/60

(57) ABSTRACT

A plasma display apparatus comprises a plasma display panel and an electrode driver. The plasma display panel includes a first driving electrode and a second driving electrode. The electrode driver supplies a pulse of a second polarity to the second driving electrode and a pulse of a first polarity opposite to the second polarity to the first driving electrode after a supply of a last sustain pulse of the first polarity to the second electrode. The pulse of the second polarity overlaps the pulse of the first polarity.

This application claims the benefit of Korean Patent Application No. 10-2006-0030240 filed on Apr. 3, 2006, which is hereby incorporated by reference.

### BACKGROUND

1. Field

This document is related to a plasma display apparatus and a driving method of the plasma display apparatus.

2. Description of the Related Art

A plasma display apparatus includes a plasma display panel and a driver. The plasma display panel includes a discharge cell partioned by a barrier rib. The driver supplies a driving singal to an electrode of the plasma display panel. As a result of a supply of the driving signal, a discharge occurs in the discharge cell, and excites a phosphor of the discharge cell. When the discharge excites the discharge cell, the phosphor generates light.

The plasma display apparatus achieves grey levels with a combination of subfields. The plasma display apparatus emits light during each subfield, and the grey levels are achieved by a sum of light amount emitted during each subfield.

Each subfield includes a reset period, an address period, and a sustain period. During the reset period, wall discharges of entire discharge cells of the plasma display panel are uniformed. Some discharge cells of the entire discharge cells are selected during the address period. The selected discharge cells emit light during the sustain period.

### SUMMARY

In one aspect, a plasma display apparatus comprises a plasma display panel including a first driving electrode and a second driving electrode and an electrode driver supplying a pulse of a second polarity to the second driving electrode and a pulse of a first polarity opposite to the second polarity to the first driving electrode after a supply of a last sustain pulse of the first polarity to the second electrode, wherein the pulse of the second polarity overlaps the pulse of the first polarity.

In another aspect, A driving method of a plasma display apparatus including a first driving electrode and a second driving electrode, comprises supplying a last sustain pulse of a first polarity to the second driving electrode, supplying a pulse of a second polarity opposite to the first polarity to the second driving electrode and supplying a pulse of the first polarity to the first driving electrode, wherein the pulse of the second polarity overlaps the pulse of the first polarity.

### BRIEF DESCRIPTION OF THE DRAWINGS

The embodiment will be described in detail with reference to the following drawings in which like numerals refer to like elements.

FIG. 1 illustrates a plasma display apparatus according to an embodiment;

FIG. 2a illustrates a first embodiment of a driving pulse of the plasma display apparatus according to the embodiment;

FIG. 2b illustrates another waveform of a reset pulse of the first embodiment of FIG. 2a;

FIG. 3a to FIG. 3c illustrate variation of wall discharges according to the first embodiment of FIG. 2a;

FIG. 4 illustrates a second embodiment of a driving pulse of the plasma display apparatus according to the embodiment;

FIG. 5 illustrates a third embodiment of a driving pulse of the plasma display apparatus according to the embodiment;

FIGS. 6a and 6b illustrate a fourth and a fifth embodiments of driving pulses of the plasma display apparatus according to the embodiment;

FIG. 7 illustrates a sixth embodiment of a driving pulse of the plasma display apparatus according to the embodiment;

FIGS. 8a to 8c illustrate variation of wall discharges according to the sixth embodiment;

FIG. 9 illustrates a seventh embodiment of a driving pulse of the plasma display apparatus according to the embodiment; and

FIGS. 10a and 10b illustrate an eighth and a ninth embodiments of driving pulses of the plasma display apparatus according to the embodiment.

### DETAILED DESCRIPTION OF EMBODIMENTS

In one aspect, a plasma display apparatus comprises a plasma display panel including a first driving electrode and a second driving electrode and an electrode driver supplying a pulse of a second polarity to the second driving electrode and a pulse of a first polarity opposite to the second polarity to the first driving electrode after a supply of a last sustain pulse of the first polarity to the second electrode, wherein the pulse of the second polarity overlaps the pulse of the first polarity.

The pulse of the first polarity may be a positive pulse, and the pulse of the second polarity may be a negative pulse.

The pulse of the first polarity may be a negative pulse, and the pulse of the second polarity may be a positive pulse.

At least a portion of a rising period of the pulse of the second polarity may overlap at least a portion of the pulse of the first polarity.

At least a portion of a falling period of the pulse of the second polarity may overlap at least a portion of the pulse of the first polarity.

The electrode driver may supply peak voltages of the pulses of the first polarity and the second polarity during at least a portion of a period when the pulses overlap each other.

The period when the peak voltages of the pulses of the first polarity and the second polarity are supplied may be equal to or less than 100 ns.

The pulse of the first polarity may be a reset pulse.

A magnitude of a peak voltage of the pulse of the second polarity may range from ⅓ to ½ of a magnitude of a peak voltage of the pulse of the first polarity.

A pulse pair may include the pulses of the first polarity and the second polarity, and the electrode driver may supply a plurarity of the pulse pairs.

The pulses of the first polarity and the second polarity may be supplied before a supply of a reset pulse.

In another aspect, A driving method of a plasma display apparatus including a first driving electrode and a second driving electrode, comprises supplying a last sustain pulse of a first polarity to the second driving electrode, supplying a pulse of a second polarity opposite to the first polarity to the second driving electrode and supplying a pulse of the first polarity to the first driving electrode, wherein the pulse of the second polarity overlaps the pulse of the first polarity.

The pulse of the first polarity may be a positive pulse, and the pulse of the second polarity is a negative pulse.

The pulse of the first polarity may be a negative pulse, and the pulse of the second polarity is a positive pulse.

At least a portion of a rising period of the pulse of the second polarity may overlap at least a portion of the pulse of the first polarity.

At least a portion of a falling period of the pulse of the second polarity may overlap at least a portion of the pulse of the first polarity.

Peak voltages of the pulses of the first polarity and the second polarity may be supplied during at least a portion of a period when the pulses overlap each other.

The period when the peak voltages of the pulses of the first polarity and the second polarity are supplied may be equal to or less than 100 ns.

The pulse of the first polarity may be a reset pulse.

A magnitude of a peak voltage of the pulse of the second polarity may range from ⅓ to ½ of a magnitude of a peak voltage of the pulse of the first polarity.

A pulse pair may include the pulses of the first polarity and the second polarity, and a plurarity of the pulse pairs may be supplied.

The pulses of the first polarity and the second polarity may be supplied before a supply of a reset pulse.

Embodiments will be described in a more detailed manner with reference to the drawings.

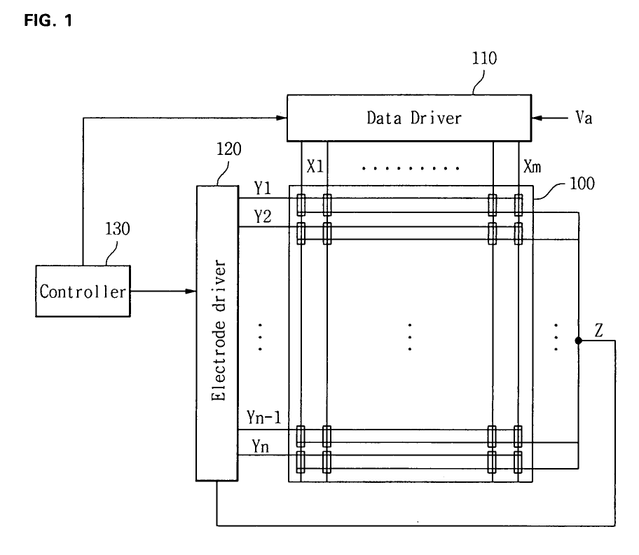

FIG. 1 illustrates a plasma display apparatus according to an embodiment. As illustrated in FIG. 1, the plasma display apparatus according to the embodiment includes a plasma display panel 100, a data driver 110, an electrode driver 120 and controller 130.

The plasma display panel 100 includes a first driving electrode and a second driving electrode. The first driving electrode may be a scan electrode Y1-Yn, and the second driving electrode may be a sustain electrode Z. The plasma display panel 100 includes an address electrode X1-Xm.

The data driver 110 supplies an address pulse to the address electrode X1-Xm of the plasma display panel 100 during an address period to select a discharge cell in which a sustain discharge is to occur. The data driver 110 voltage Va or a ground level voltage to the address electrode X1-Xm for a supply of the address pulse.

The electrode driver 120 drives the first and the second driving electrodes For example, the electrode driver 120 supplies a reset pulse during a reset period, and a scan pulse and a scan reference pulse during an address period, and a sustain pulse during a sustain period, to the scan electrode Y1-Yn. The electrode driver 120 supplies a bias voltage during the address period and a sustain pulse during the sustain period, to the sustain electrode Z.

The electrode driver 120 supplies a pulse of a second polarity to the second driving electrode and a pulse of a first polarity opposite to the second polarity to the first driving electrode after a supply of a last sustain pulse of the first polarity to the second electrode. The pulse of the second polarity overlaps the pulse of the first polarity. An operation of the electrode driver will be described in detail.

The controller 130 controls the data driver 110 and the electrode driver 120.

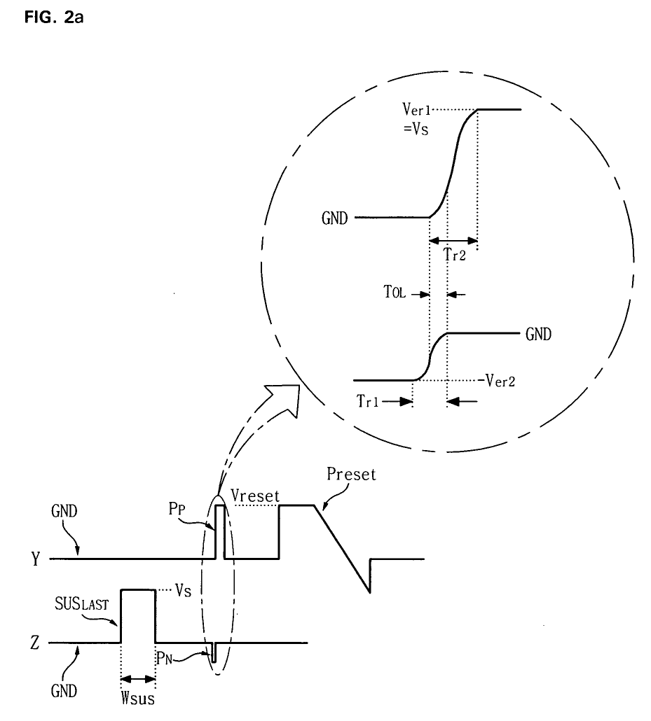

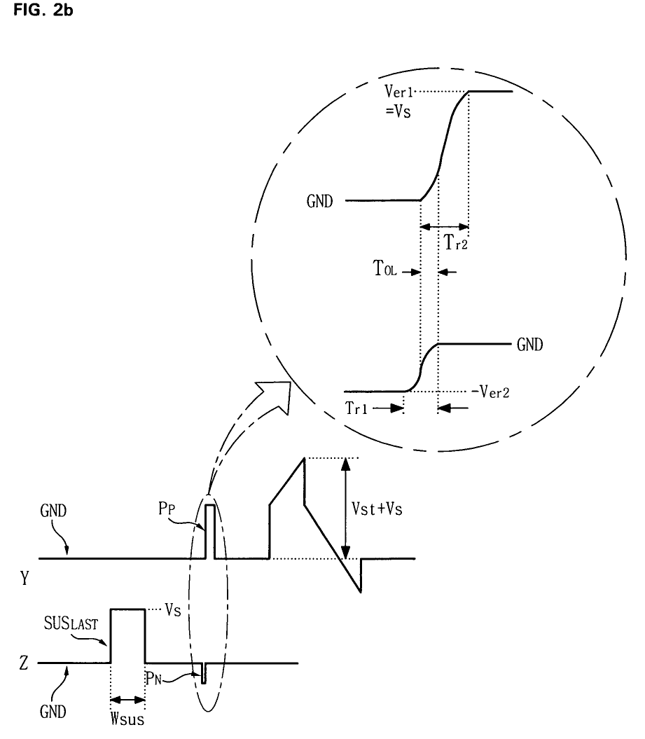

FIG. 2a illustrates a first embodiment of a driving pulse of the plasma display apparatus according to the embodiment. In the first embodiment of the driving pulse of FIG. 2a, the pulse of the second polarity is supplied before the pulse of the first polarity. In FIG. 2a, the pulse of the first polarity may be a positive pulse P_{P}, and the pulse of the second polarity may be a negative pulse P_{N}.

As illustrated in FIG. 2a, the electrode driver 120 of FIG. 1 supplies a negative pulse P_{N} to the sustain electrode Z after a supply of a last positive sustina pulse SUS_{LAST} during a sustain period to a sustain electrode Z, and supplies a positive pulse P_{P} which overlaps the negative pulse P_{N} during a overlap period T_{OL}, to the scan electrode Y.

A duration of the overlap period T_{OL} may be the time when at least a portion of a rising period Tr1 of the negative pulse P_{N} overlaps at least a portion of a rising period Tr2 of the positive pulse P_{P}. For example, when the rising period Tr2 of the positive pulse P_{P} is 150 ns, the overlap period may be 30 ns.

The electrode driver 120 supplies peak voltages −Ver2, Ver1 of the negative pulse P_{N} and the positive pulse P_{P} during at least a portion of the overlap period.

The period when the peak voltages −Ver2, Ver1 of the negative pulse P_{N} and the positive pulse P_{P} are supplied may be equal to or less than 100 ns. When the period is equal to or less than 100 ns, an occurrence of light is limited and a contrast ratio improves.

An erasing time decreases because of an increase of a voltage difference between the scan electrode Y and the sustain electrode Z due to the overlap of the negative pulse P_{N} and the positive pulse Pₚ during the overlap period T_{OL}. For example, when the peak voltages Ver1 and −Ver2 of the positive pulse P_{P} and the negative pulse P_{N} is respectively 180V and −90V, the voltage difference between the scan electrode Y and the sustina electrode Z is 270V. As a result of the voltage difference (=270V), an erase is performed for short time.

The erase of the wall charges makes a deviation of the wall charges between the discharge cells decrease. Accordingly, a highest voltage of the reset pulse Preset of FIG. 2a can be decreased. As a result of the decrease of the highest voltage of the reset pulse Preset, a light amount emitted by the reset pulse Preset is decreased, and the contrast ratio of the plasma display apparatus according to the embodiment improves.

In the case that the negative pulse (P_{N}) and the positive pulse P_{P} cannot erase the wall charges perfectly, As illustrated in FIG. 2b, the electrode driver 120 makes an amount of the wall charges of each discharge cell uniformed by increasing the highest voltage of the reset pulse Preset to a voltage Vst+Vs.

A magnitude of a peak voltage −Ver2 of the negative pulse P_{N} may range from ⅓ to ½ of a magnitude of a peak voltage Ver1 of the positive pulse P_{P}. For example, when the magnitude of the peak voltage Ver1 of the positive pulse P_{P} is 180V, the magnitude of the peak voltage −Ver2 of the negative pulse P_{N} ranges from −90V to −60V. When the magnitude of the peak voltage −Ver2 of the negative pulse P_{N} ranges from ⅓ to ½ of the magnitude of the peak voltage Ver1 of the positive pulse P_{P} the wall charges can be erased without a high voltage such as a sustain voltage Vs. The sustain voltage Vs is a highest voltage of a sustain pulse. A width of the positive pulse P_{P} may range 2 μs to 2.5 μs, and a width of the negative pulse P_{N} may range 150 ns to 2 μs.

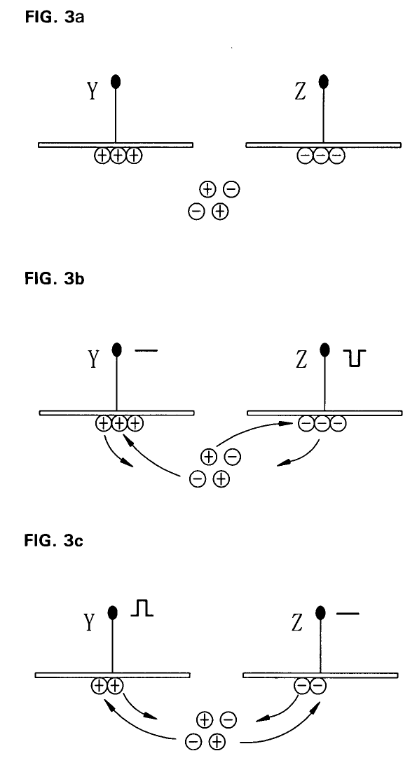

FIG. 3a to FIG. 3c illustrate variation of wall discharges according to the first embodiment of FIG. 2a.

As illustrated FIG. 3a, when the last sustain pulse SUS_{LAST} is supplied to the sustain electrode Z, positive wall charges are formed on the scan electrode Y and negative wall charges are formed on the sustain electrode Z.

As illustrated FIG. 3b, when the negative pulse is supplied to the sustain electrode Z, the negative charges on the sustain electrode Z move to discharge space. The positive charges of the discharges space move to the sustain electrode Z, and are combined with the negative charges on the sustina electrode Z. As a result of the combination of the positive charges and the negative charges, the negative charges are erased. The positive charges on the scan electrode Y move to the discharge space. The negative charges of the discharge space move to the scan electrode Y, and are combined with the positive charges on the scan electrode Y. Due to the combination of the positive charges and the negative charges, the positive charges on the scan electrode Y are erased.

As illustrated in FIG. 3c, when the positive pulse is supplied to the scan electrode Y after a supply of the negative pulse to the sustain electrode Z, the positive charges on the scan electrode Y move to the discharge space. The negative charges of the discharge space move to the scan electrode Y, and are combined with the positive charges on the scan electrode Y. As a result of the combination of the positive charges and the negative charges, the positive charges on the scan electrode Y are erased. The negative charges on the sustain electrode Z move to the discharge space. The positive charges of the discharge space move to the sustain electrode Z, and are combined with the negative charges on the sustain electrode Z. Accordingly, the negative charges on the sustain electrode Z are erased.

Because the negative pulse supplied to the sustain electrode Z overlaps the positive pulse supplied to the scan electrode Y during the overlap period, the voltage difference between the scan electrode Y and the sustain electrode Z increases, and an erase of wall charges is performed for short time.

In case that the lase sustain pulse SUSLAST is supplied to the scan electrode Y, a negative pulse is supplied to the scan electrode Y before a supply of a positive pulse to the sustain electrode Z. The negative pulse supplied to the scan electrode Y overlaps the positive pulse supplied to the sustain electrode Z during an overlap period.

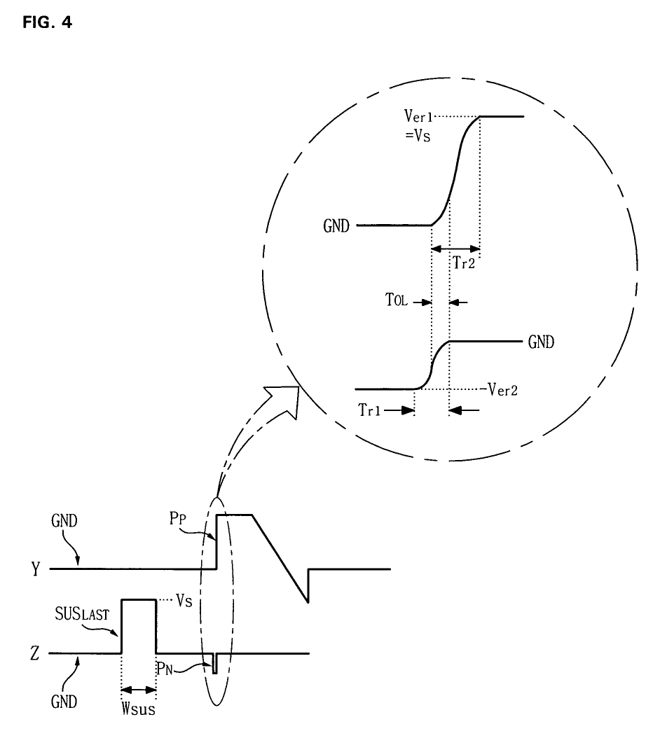

FIG. 4 illustrates a second embodiment of a driving pulse of the plasma display apparatus according to the embodiment. As illustrated in FIG. 4, the electrode driver 120 in FIG. 2a supplies the negative pulse P_{N} to the sustain electrode Z after a supply of the last positive sustain pulse SUSLAST to the sustain electrode Z during the sustain period, and supplies a positive pulse P_{P}, which overlaps the negative pulse P_{N} during the overlap period TOL, to the scan electrode. The positive pulse supplied to the scan electrode Y may be a reset pulse. The description is omitted. The detailed description of the overlap period TOL and the peak voltages of the negative pulse P_{N} and the positive pulse P_{P} is the same as the first embodiment of FIG. 2a, thus being omitted.

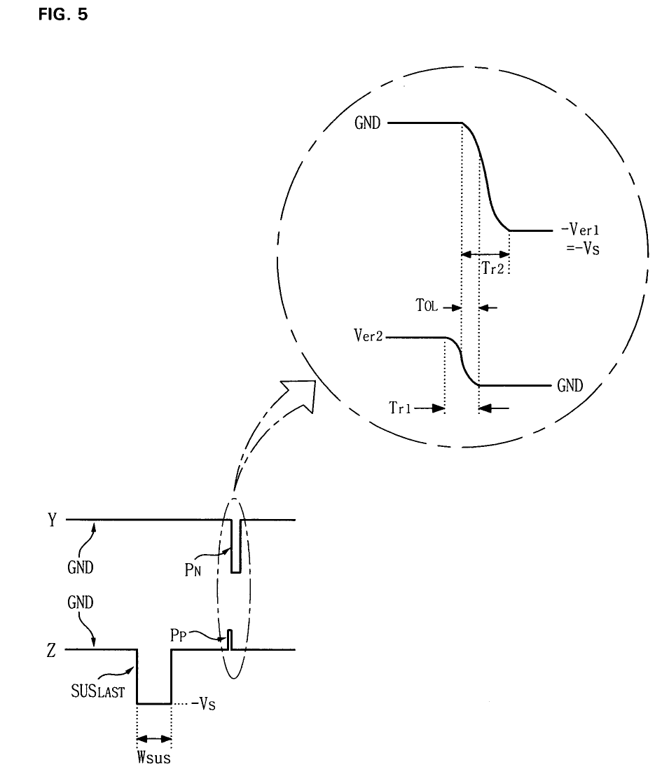

FIG. 5 illustrates a third embodiment of a driving pulse of the plasma display apparatus according to the embodiment. In the third embodiment of the driving pulse, a pulse of the second polarity is supplied before a supply of a pulse of the first polarity, the last sustain pulse has a negative polarity, the pulse of the first polarity is a negative pulse P_{N}, and the pulse of the second polarity is a positive pulse P_{P}.

For example, as illustrated in FIG. 5, the electrode driver 120 supplies the positive pulse P_{P} to the sustain electrode Z after a supply of the last sustain pulse SUS_{LAST} to the sustain electrode Z during the sustina period, and supplies the negative pulse P_{N}, which overlaps the positive pulse P_{P} during the overlap period T_{OL}, to the scan electrode Y.

The overlap period T_{OL} may be the time when at least a portion of a falling period Tf1 of the positive pulse P_{P} overlaps at least a portion of a falling period Tf2 of the negative pulse P_{N}. For example, when the falling period Tf2 of the negative pulse P_{N} may be 150 ns, The overlap period T_{OL} may be 30 ns.

The electrode driver 120 may supply peak voltages −Ver1, Ver2 of the negative pulse P_{N} and the positive pulse P_{P} during at least a portion of the period when the negative pulse P_{N} and the positive pulse P_{P} overlap each other.

When the period when the peak voltages −Ver1, Ver2 of the positive pulse P_{P} and the negative pulse P_{N} are supplied is equal to or less than 100 ns, a generation of light is limited and the contrast ration improves.

During the overlap period T_{OL}, the negative pulse P_{N} overlaps the positive pulse P_{P} and the voltage difference between the scan electrode Y and the sustain electrode Z increases. Accordingly, an erase time of wall charges decreases.

In case that a magnitude of a peak voltage Ver2 of the positive pulse P_{P} may range from ⅓ to ½ of a magnitude of a peak voltage −Ver1 of the negative pulse, the wall charges can be erased without a high voltage such as a negative sustain voltage −Vs.

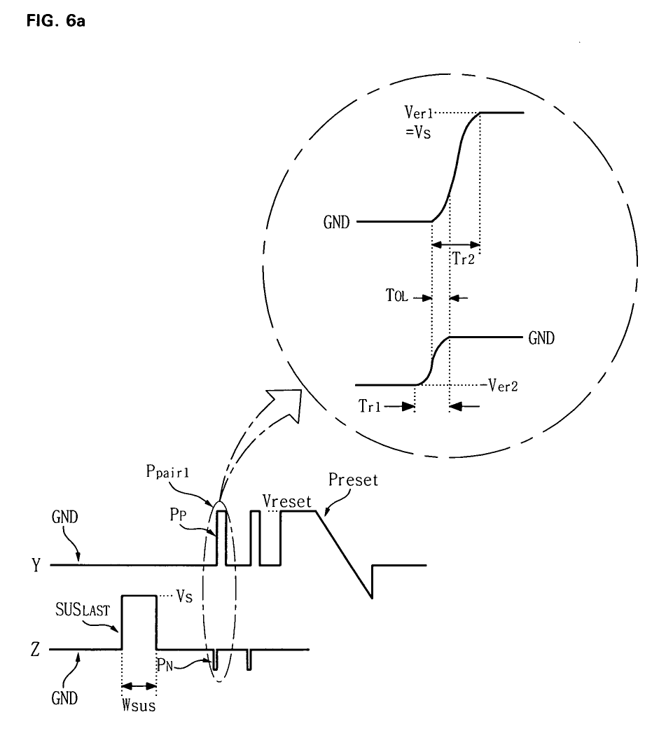

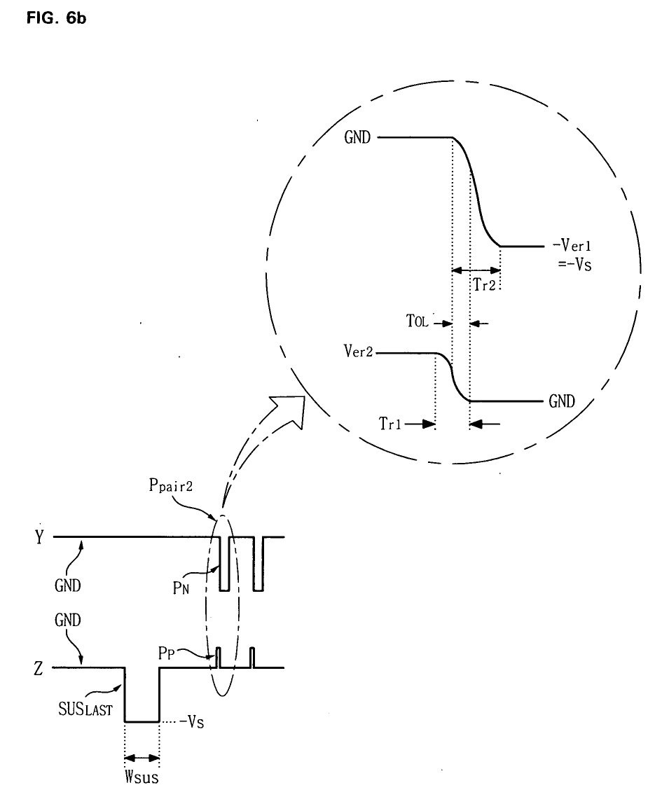

FIGS. 6a and 6b illustrate a fourth and a fifth embodiments of driving pulses of the plasma display apparatus according to the embodiment. In the fourth and the fifth embodiments of the driving pulses, the electrode driver 120 may supply a plurarity of the pulse pairs Ppair1, Ppair2. The pulse pair includes the pulses of the first polarity and the second polarity. In the fourth embodiment of the driving pulse, the pulse pair Ppair1 includes the negative pulse P_{N} and the positive pulse P_{P} of FIG. 2a. In the fifth embodiment of the driving pulse, the pulse pair Ppair2 includes the negative pulse P_{N} and the positive pulse P_{P} of FIG. 5.

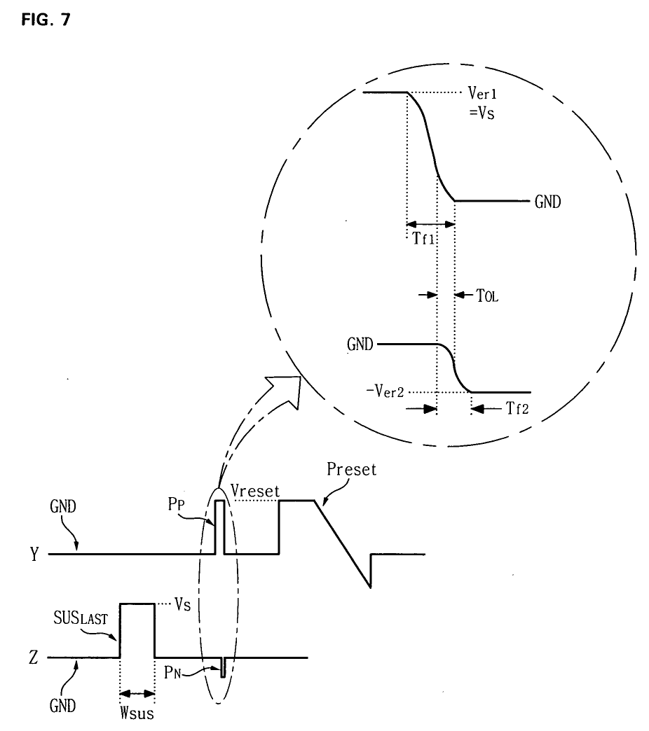

FIG. 7 illustrates a sixth embodiment of a driving pulse of the plasma display apparatus according to the embodiment. In the sixth embodiment of the driving pulse, the pulse of the second polarity is supplied after a supply of the pulse of the first polarity. The last sustain pulse SUS_{LAST} has the positive polarity, the pulse of the first polarity is a positive pulse P_{P}, and the pulse of the second polarity is a negative pulse P_{N}.

As illustrated in FIG. 7, the electrode driver 120 of FIG. 1 supplies the positive pulse P_{P} to the scan electrode Y after a supply of the last sustain pulse SUS_{LAST} to the sustain electrode Z during a sustain period, and supplies the negative pulse P_{N}, which overlaps the positive pulse P_{P} during the overlap period T_{OL}, to the sustain electrode z.

The overlap period T_{OL} may be the time when at least a portion of a falling period Tf1 of the positive pulse P_{P} overlaps at least a portion of a falling period Tf2 of the negative pulse P_{N}.

The electrode driver 120 may supply peak voltages −Ver2, Ver1 of the positive pulse P_{P} and the negative pulse P_{N} during at least a portion of a period when the positive pulse P_{P} and the negative pulse P_{N} overlap each other. The detailed description of a supply period and magnitudes of the peak voltages −Ver2, Ver1 is the same as the first embodiment, thus being omitted.

The voltage difference between the scan electrode Y and the sustain electrode Z increases during the overlap period T_{OL} due to the overlap of the negative pulse P_{N} and the positive pulse P_{P}. Accordingly, an erase time of wall charges and the highest voltage decrease.

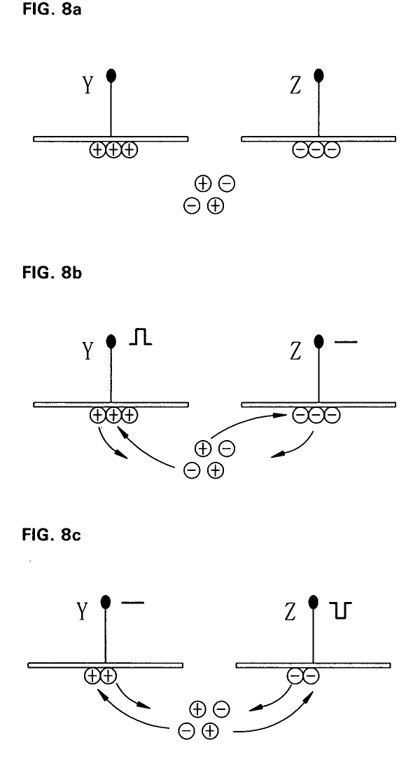

FIGS. 8a to 8c illustrate variation of wall discharges according to the sixth embodiment. As illustrated in FIG. 8a, when the last positive sustain pulse SUS_{LAST} is supplied to the sustain electrode Z, positive wall charges are formed on the scan electrode Y, and negative wall charges are formed on the sustain electrode Z.

As illustrated in FIG. 8b, when the positive pulse is supplied to the scan electrode Y, the positive wall charges on the scan electrode Y move to discharge space. Negative charges of the discharge space move to the scan electrode Y, and are combined with the positive wall charges on the scan electrode Y. As a result of combination of the positive and the negative charges, the positive wall charges on the scan electrode Y are erased. Due to the supply of the negative pulse to the sustain electrode Z, the negative wall charges on the sustain electrode Z move to the discharge space, and the positive charges move to the sustain electrode Z. As a result of move of the positive and the negative charges, the positive charges are combined with the negative charges on the sustain electrode Z. Accordingly, the negative charges on the sustain electrode Z are erased.

As illustrated in FIG. 8c, when the negative pulse is supplied to the sustain electrode Z after the supply of the positive pulse to the scan electrode, the negative charges on the sustain electrode Z move to the discharge space, and the positive charges of the discharge space move to the sustain electrode Z. As a result of move of the positive charges to the sustain electrode Z, the positive charges are combined with the negative charges on the sustain electrode Z, and the negative charges are combined with the positive charges on the scan electrode Y. Due to the combination of the positive and the negative charges, the positive charges and the negative charges on the scan electrode Y and the sustain electrode Z are erased.

Because the negative pulse supplied to the sustain electrode Z overlaps the positive pulse supplied to the scan electrode Y, a voltage difference between the scan electrode Y and the sustain electrode Z increases, and an erase of wall charges occurs for short time.

In case that the last sustain pulse SUS_{LAST} is supplied to the scan electrode Y, the positive pulse is supplied to the sustain electrode Z before a supply to the negative pulse, which overlaps the positive pulse, to the scan electrode Y.

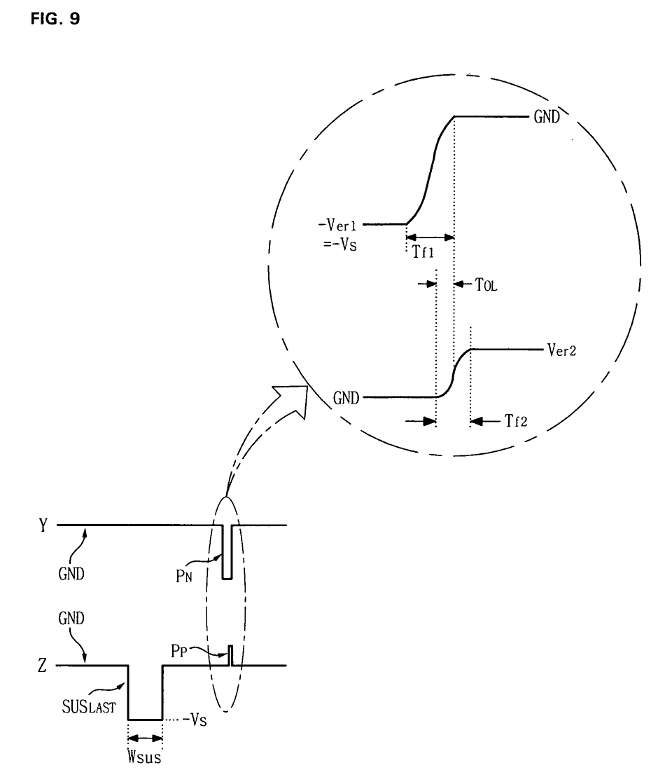

FIG. 9 illustrates a seventh embodiment of a driving pulse of the plasma display apparatus according to the embodiment. In the seventh embodiment of the driving pulse, a pulse of the second polarity is supplied after a pulse of the first polarity. In the seventh embodiment of the driving pulse, the last sustain pulse SUS_{LAST} has a negative polarity, the pulse of the first polarity is a negative pulse P_{N}, and the pulse of the second polarity is a positive pulse P_{P}.

As illustrated in FIG. 9, the electrode driver 120 of FIG. 1 supplies a negative pulse P_{N} to the scan electrode Y after supplying a last negative sustain pulse SUS_{LAST} to the sustain electrode Z during the sustain period, and supplies a positive pulse P_{P}, which overlaps the negative pulse P_{N} during a overlap period T_{OL}, to the sustain electrode Z.

The overlap period T_{OL} may be the time when at least a portion of the rising period Tr1 of the negative pulse P_{N} overlaps at least a portion of the positive pulse P_{P}.

The electrode driver 120 may supply peak voltages Ver2, −Ver1 of the negative pulse P_{N} and the positive pulse P_{P} during at least a portion of a period when the negative pulse P_{N} and the positive pulse P_{P} overlap each other. The detailed description of a supply period and magnitudes of peak voltages Ver2, −Ver1 is the same as the third embodiment, thus being omitted.

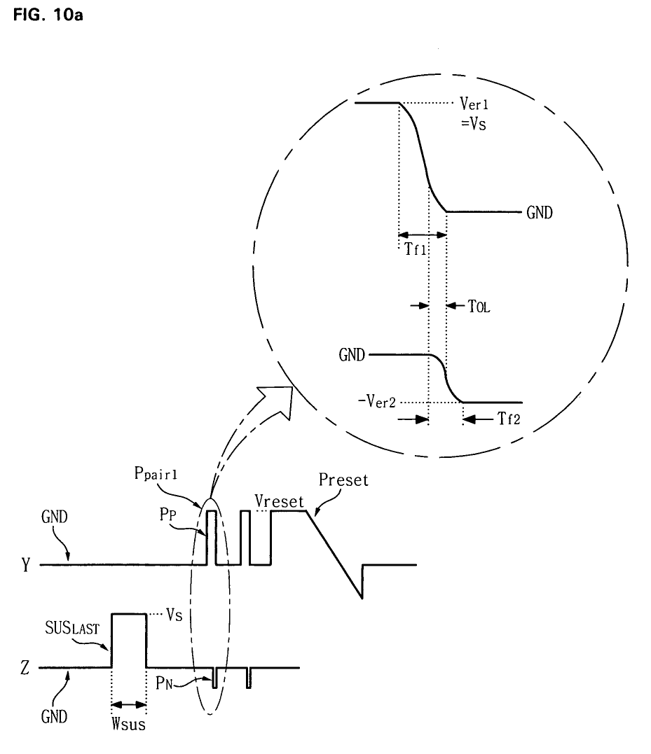

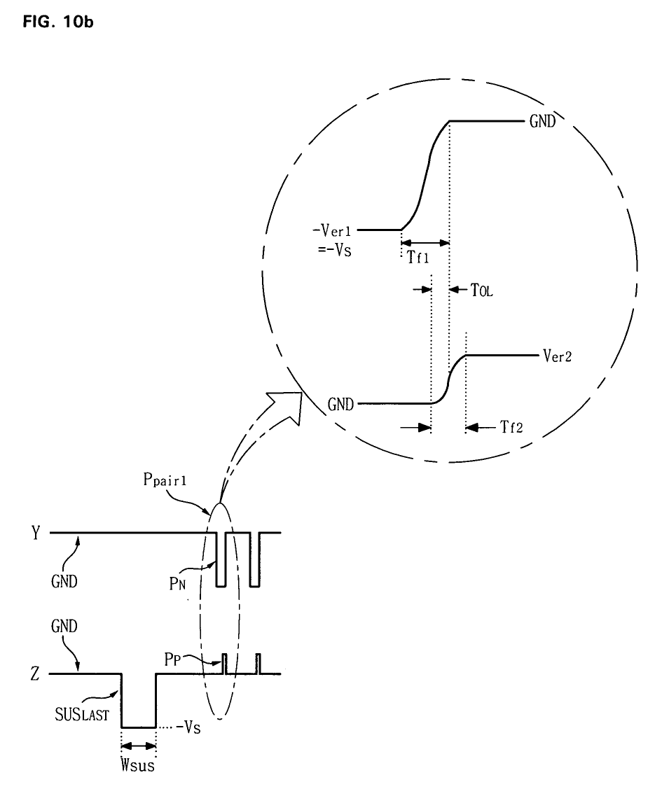

FIGS. 10a and 10b illustrate an eighth and a ninth embodiments of driving pulses of the plasma display apparatus according to the embodiment. In the eighth and the ninth embodiments, the electrode driver 120 may supply a plurarity of the pulse pairs Ppair1, Ppair2. The pulse pair includes the pulses of the first polarity and the second polarity. In the eighth embodiment, the pulse pair Ppair1 includes the negative pulse P_{N} and the positive pulse P_{P} of FIG. 7. In the ninth embodiment, the pulse pair Ppair2 includes the negative pulse P_{N} and the positive pulse P_{P} of FIG. 9. When the plurarity of the pulse pairs Ppair1, Ppair2 are supplied, an erase amount of wall charges increases, a deviation of wall charges of discharge cells and a highest voltage of a reset pulse decrease, and a contrast ratio increases.

In the rest embodiments except for the second embodiment among the first to the ninth embodiments, the pulses of the first polarity and the second polarity are supplied before a supply of the reset pulse. When widths of the pulses of the first polarity and the second polarity are less than a width of the last sustain pulse, an erase time of wall charges decreases, and a contrast characteristic improves. For example, the first embodiment of FIG. 2a, the width Wp of the positive pulse P_{P} and the width Wn of the positive pulse P_{N} are less than the width Wsus of the last positive sustain pulse SUS_{LAST}.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel including a first driving electrode and
a second driving electrode; and
an electrode driver supplying a pulse of a second polarity to the second driving electrode and a pulse of a first polarity opposite to the second polarity to the first driving electrode after a supply of a last sustain pulse of the first polarity to the second electrode,
wherein the pulse of the second polarity overlaps the pulse of the first polarity.

2. The plasma display appratus of claim 1, wherein
the pulse of the first polarity is a positive pulse, and the pulse of the second polarity is a negative pulse.

3. The plasma display appratus of claim 1, wherein
the pulse of the first polarity is a negative pulse, and the pulse of the second polarity is a positive pulse.

4. The plasma display appratus of claim 1, wherein
at least a portion of a rising period of the pulse of the second polarity overlaps at least a portion of the pulse of the first polarity.

5. The plasma display appratus of claim 1, wherein
at least a portion of a falling period of the pulse of the second polarity overlaps at least a portion of the pulse of the first polarity.

6. The plasma display appratus of claim 1, wherein
the electrode driver supplies peak voltages of the pulses of the first polarity and the second polarity during at least a portion of a period when the pulses overlap each other.

7. The plasma display appratus of claim 6, wherein
the period when the peak voltages of the pulses of the first polarity and the second polarity are supplied is equal to or less than 100 ns.

8. The plasma display appratus of claim 1, wherein
the pulse of the first polarity is a reset pulse.

9. The plasma display appratus of claim 1, wherein
a magnitude of a peak voltage of the pulse of the second polarity ranges from ⅓ to ½ of a magnitude of a peak voltage of the pulse of the first polarity.

10. The plasma display appratus of claim 1, wherein
a pulse pair includes the pulses of the first polarity and the second polarity, and
the electrode driver supplies a plurarity of the pulse pairs.

11. The plasma display appratus of claim 1, wherein
the pulses of the first polarity and the second polarity are supplied before a supply of a reset pulse.

12. A driving method of a plasma display appratus including a first driving electrode and a second driving electrode, comprising:
supplying a last sustain pulse of a first polarity to the second driving electrode;
supplying a pulse of a second polarity opposite to the first polarity to the second driving electrode; and
supplying a pulse of the first polarity to the first driving electrode,
wherein the pulse of the second polarity overlaps the pulse of the first polarity.

13. The driving method of the plasma display appratus of claim 12, wherein
the pulse of the first polarity is a positive pulse, and the pulse of the second polarity is a negative pulse.

14. The driving method of the plasma display appratus of claim 12, wherein
the pulse of the first polarity is a negative pulse, and the pulse of the second polarity is a positive pulse.

15. The driving method of the plasma display appratus of claim 12, wherein
at least a portion of a rising period of the pulse of the second polarity overlaps at least a portion of the pulse of the first polarity.

16. The driving method of the plasma display appratus of claim 12, wherein
at least a portion of a falling period of the pulse of the second polarity overlaps at least a portion of the pulse of the first polarity.

17. The driving method of the plasma display appratus of claim 12, wherein
peak voltages of the pulses of the first polarity and the second polarity are supplied during at least a portion of a period when the pulses overlap each other.

18. The driving method of the plasma display appratus of claim 17, wherein
the period when the peak voltages of the pulses of the first polarity and the second polarity are supplied is equal to or less than 100 ns.

19. The driving method of the plasma display appratus of claim 12, wherein
the pulse of the first polarity is a reset pulse.

20. The driving method of the plasma display appratus of claim 12, wherein
a magnitude of a peak voltage of the pulse of the second polarity ranges from ⅓ to ½ of a magnitude of a peak voltage of the pulse of the first polarity.

21. The driving method of the plasma display appratus of claim 12, wherein
a pulse pair includes the pulses of the first polarity and the second polarity, and a plurarity of the pulse pairs are supplied.

22. The driving method of the plasma display appratus of claim 12, wherein
the pulses of the first polarity and the second polarity are supplied before a supply of a reset pulse.
